(19) United States
(12) Patent Application Publication
(10) Pub. No.: US 2024/0238745 A1
(43) Pub. Date: Jul. 18, 2024

(54) VOLUMETRIC MIXER WITH PIVOTABLE CHUTE

(71) Applicant: Cemen Tech, Inc., Indianola, IA (US)

(72) Inventors: Brian Kenoyer, Ankeny, IA (US); Matthew Wallin, Indianola, IA (US)

(21) Appl. No.: 18/411,208

(22) Filed: Jan. 12, 2024

Related U.S. Application Data
(60) Provisional application No. 63/479,905, filed on Jan. 13, 2023.

(51) Int. Cl. B01F 35/75; B01F 27/114

(52) U.S. Cl. CPC B01F 35/7548; B01F 27/114; B01F 2101/28

(57) ABSTRACT

Disclosed is a volumetric mixer comprising a mixing auger and a chute pivotally connected to the mixing auger such that a pivot axis of the chute is substantially horizontal and above an exit of the mixing auger.

### BACKGROUND

This application claims the benefit of U.S. Provisional Patent Application No. 63/479,905 which was filed with the United States Patent and Trademark Office on Jan. 13, 2023, the entire contents of each of which is herein incorporated by reference.

### 1. FIELD

Example embodiments disclose a volumetric mixer with a pivotable chute. In at least one example embodiment, the chute may be pivoted over a volumetric mixer's mixing auger.

### 2. DESCRIPTION OF THE RELATED ART

Volumetric mixers are used to mix a variety of solid and liquid materials to produce concrete. These mixers typically include separate compartments for aggregates, cementitious material, and supplementary materials. These materials may be fed to a mixing auger (inside a housing) which mixes the materials and moves the material out of the mixing auger through an exit and onto a chute attached to an end of the mixing auger. In some volumetric mixers the chute is bolted to the mixing auger so that as the material leaves the auger it can be directionally controlled by the chute. While having a chute offers directional control, there are times an operator may prefer to use the volumetric mixer in a continuous pour operation. This requires the operator to unbolt the chute and remove it to enable continuous pouring of concrete.

### SUMMARY

Example embodiments relate to a volumetric mixer. In at least one example embodiment the volumetric mixer includes a mixing auger and a chute pivotally connected to the mixing auger such that a pivot axis of the chute is substantially horizontal. In some embodiments the pivot axis is above a discharge end of the mixing auger.

### BRIEF DESCRIPTION OF THE DRAWINGS

Example embodiments are described in detail below with reference to the attached drawing figures, wherein:

FIG. 1 is a first perspective view of a chute assembly and mixing auger in accordance with a first example embodiment;

FIG. 2 is a second perspective view of the chute assembly and mixing auger in accordance with the first example embodiment;

FIG. 3 is a third perspective view of the chute assembly and mixing auger in accordance with the first example embodiment;

FIG. 4 is a fourth perspective view of the chute assembly and mixing auger in accordance with the first example embodiment;

FIG. 5 is a fifth perspective view of the chute assembly and mixing auger in accordance with the first example embodiment.

FIG. 6 is a sixth perspective view of the chute assembly and mixing auger in accordance with the first example embodiment;

FIG. 7 is a first side view of the chute assembly and mixing auger in accordance with an example embodiment;

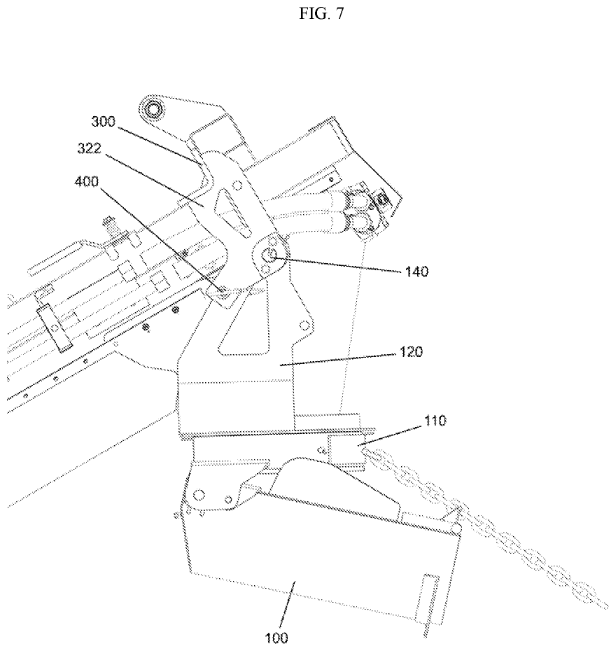

FIG. 8 is another perspective view of the chute assembly and mixing auger in accordance with the first example embodiment;

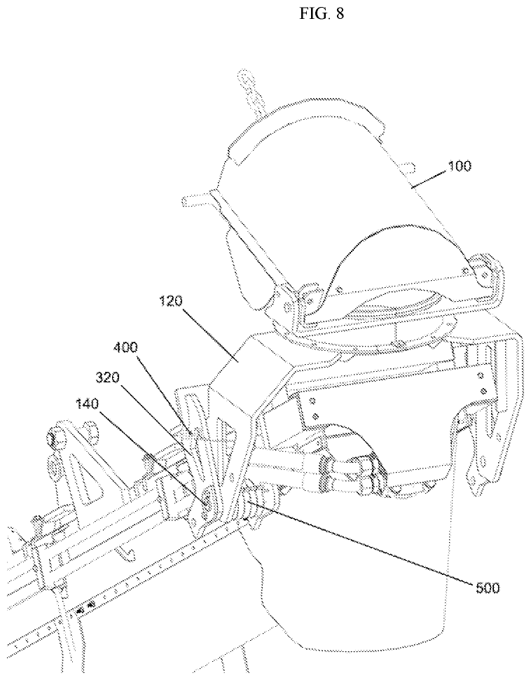

FIG. 9 is another perspective view of the chute assembly and mixing auger in accordance with the first example embodiment;

FIG. 10 is another perspective view of the chute assembly and mixing auger in accordance with the first example embodiment;

FIG. 11 is another perspective view of the chute assembly and mixing auger having a pin removed in accordance with the first example embodiment;

FIG. 12 is another perspective view of the chute assembly and mixing auger having a pin removed in accordance with the first example embodiment;

FIG. 13 is another perspective view of the chute assembly and mixing auger having a pin removed and rotating a chute from a second position to a first position in accordance with the first example embodiment;

FIG. 14 is another perspective view of the chute assembly and mixing auger having a pin removed and rotating a chute from a second position to a first position in accordance with the first example embodiment;

FIG. 15 is another perspective view of the chute assembly and mixing auger having a pin removed and rotating a chute from a second position to a first position in accordance with the first example embodiment;

FIG. 16 is another perspective view of the chute assembly and mixing auger having a pin removed and rotating a chute from a second position to a first position in accordance with the first example embodiment;

FIG. 17 is another perspective view of the chute assembly and mixing auger having a pin removed and rotating a chute from a second position to a first position in accordance with the first example embodiment;

FIG. 18 is another perspective view of the chute assembly and mixing auger having a pin removed with the chute moved to the first position in accordance with the first example embodiment;

FIG. 19 is another perspective view of the chute assembly and mixing auger having a pin removed with the chute moved to the first position in accordance with the first example embodiment;

FIG. 20 is another perspective view of the chute assembly and mixing auger having a pin removed with the chute moved to the first position in accordance with the first example embodiment;

FIG. 21 is another perspective view of the chute assembly and mixing auger having a pin removed with the chute moved to the first position and locked in the first position accordance with the first example embodiment;

FIG. 22 is another perspective view of the chute assembly and mixing auger having a pin removed with the chute moved to the first position and locked in the first position accordance with the first example embodiment;

FIG. 23 is a first side view of a chute assembly and mixing auger in accordance with a second example embodiment;

FIG. 24 is a second side view of a chute assembly and mixing auger in accordance with the second example embodiment;

FIG. 25 is a first perspective view of a chute assembly and mixing auger in accordance with the second example embodiment;

FIG. 26 is a second perspective view of a chute assembly and mixing auger in accordance with the second example embodiment;

FIG. 27 is a third side view of a chute assembly and mixing auger in accordance with the second example embodiment;

FIG. 28 is a fourth side view of a chute assembly and mixing auger in accordance with the second example embodiment;

FIG. 29 is another perspective view of a chute assembly and mixing auger in accordance with the second example embodiment;

FIG. 30 is another perspective view of a chute assembly and mixing auger in accordance with a second example embodiment;

FIG. 31 is exploded view of a chute assembly and mixing auger in accordance with the second example embodiment;

FIG. 32 is another exploded view of a chute assembly and mixing auger in accordance with the second example embodiment;

FIG. 33 is another perspective view of a chute assembly and mixing auger in accordance with the second example embodiment;

FIG. 34 is another perspective view of a chute assembly and mixing auger in accordance with the second example embodiment;

FIG. 35 is another perspective view of a chute assembly and mixing auger in accordance with the second example embodiment;

FIG. 36 is another perspective view of a chute assembly and mixing auger in accordance with the second example embodiment;

FIG. 37 is another perspective view of a chute assembly and mixing auger having a pin removed to unlock the chute assembly in accordance with the second example embodiment;

FIG. 38 is another perspective view of a chute assembly and mixing auger having a pin removed to unlock the chute assembly in accordance with the second example embodiment;

FIG. 39 is another perspective view of a chute assembly where the chute assembly is being rotated downwards to a first position in accordance with the second example embodiment;

FIG. 40 is another perspective view of a chute assembly where the chute assembly is being rotated downwards to a first position in accordance with the second example embodiment;

FIG. 41 is another perspective view of a chute assembly where the chute assembly is being rotated downwards to a first position in accordance with the second example embodiment;

FIG. 42 is another perspective view of a chute assembly where the chute assembly is being rotated downwards to a first position in accordance with the second example embodiment;

FIG. 43 is another perspective view of a chute assembly where the chute assembly is rotated downwards to the first position in accordance with the second example embodiment;

FIG. 44 is another perspective view of a chute assembly where the chute assembly is being rotated downwards to the first position in accordance with the second example embodiment;

FIG. 45 is another perspective view of a chute assembly where the chute assembly is rotated downwards and locked in the first position in accordance with the second example embodiment; and

FIG. 46 is another perspective view of a chute assembly where the chute assembly is rotated downwards and locked in the first position in accordance with the second example embodiment.

### DETAILED DESCRIPTION

Example embodiments will now be described more fully with reference to the accompanying drawings. Example embodiments are not intended to limit the invention since the invention may be embodied in different forms. Rather, example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments disclose a volumetric mixer having a pivotable chute.

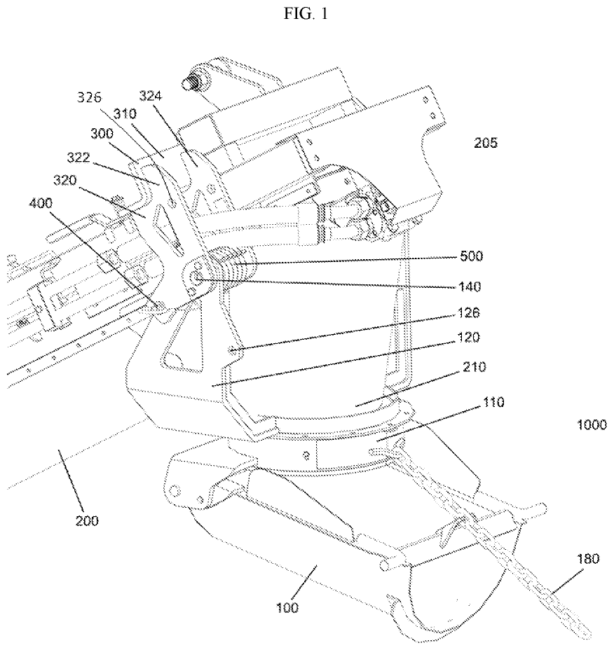

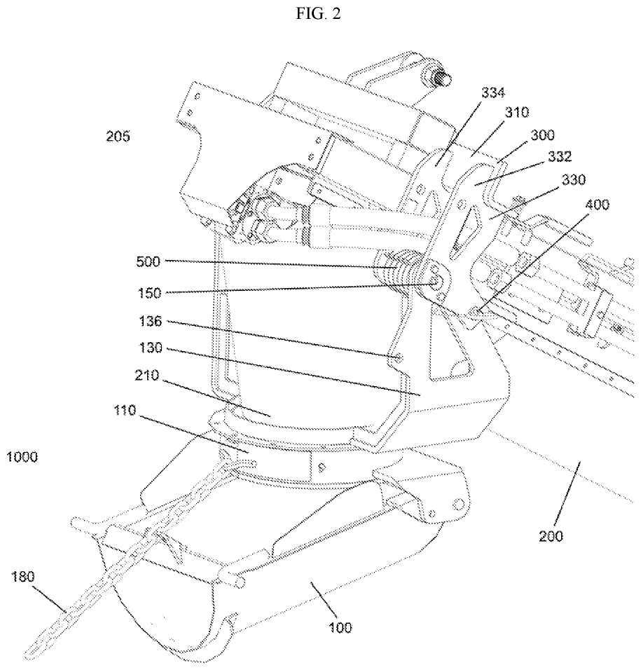

FIGS. 1 and 2 are views of a chute 100 pivotally connected to a mixing auger 200 of a volumetric mixer. Though not shown in the figures the mixing auger 200 mixes and transports various materials to form concrete which exits the mixing auger 200 at a first end 205. More specifically, the concrete flows along a length of the mixing auger 200 and out an exit 210 of the mixing auger 200. The concrete flowing out of the exit 210 flows onto the chute 100 where the concrete flows under the influence of gravity. The chute 100, as shown in the figures, may include a collar 110 allowing the chute 100 to be pivoted about an axis. In one embodiment, the axis is a vertical axis which generally passes through a center of the collar 110. In one nonlimiting example embodiment the collar 110 may resemble a first ring inside a second ring such that the first ring can rotate with respect to the second ring. For example, a user may use a chain 180 to rotate the chute 100 in a substantially horizontal plane. Mixing augers 200 are well known in the industry, thus, a detailed description thereof is omitted for the sake of brevity.

In example embodiments, a connection frame 300 may be attached to the first end 205 of the mixing auger 200. The connection frame 300 may, in one nonlimiting example embodiment, have a cross member 310 which crosses a top of the mixing auger 200 as shown in the various figures. In one nonlimiting example embodiment, the cross member 310 is bolted to a top of the mixing auger 200, in another nonlimiting example embodiment it is welded to the top of the mixing auger 200. In the various figures the cross member 310 is illustrated as having a L-shaped cross-section, however the invention is not limited thereto. For example, rather than having an L-shaped cross-section, the cross member 310 may have another cross-sectional shape such as, but not limited to, a rectangular cross section, a C-shaped cross-section, an I-shaped cross-section, an H-shaped cross-section, or a W-shaped cross-section.

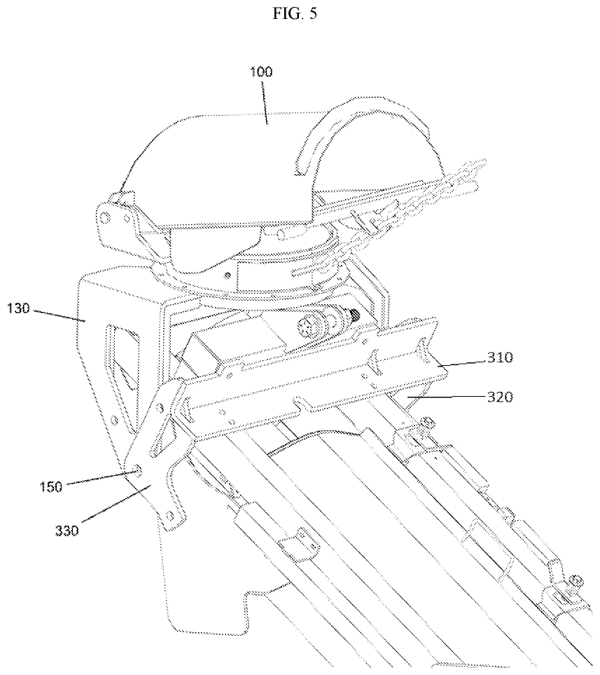

The connection frame 300 may also include a first wing 320 (see FIG. 1) and a second wing 330 (see FIG. 2) arranged at the sides of the mixing auger 200. In example embodiments, the first and second wings 320 and 330 may be embodied in various forms. For example, the first and second wings 320 and 330 may resemble single plates, in another embodiment, each of the first and second wings 320 and 330 may resemble a pair of spaced apart plates. For example, as shown in at least FIG. 1, the first wing 320 may be comprised of a pair of plates 322 and 324. The second wing 330 may be similarly constructed having a pair of plates 332 and 334. The above, however, is not intended to limit the invention. For example, whereas the first wing 320 may be comprised of a pair of plates 322 and 324, the second wing 330 may be comprised of only a single plate as shown, for example, in FIG. 5.

In example embodiments, each of the first and second wings 320 and 330 may be attached to the cross member 310 or even be integral with the cross member 310. For example, in one nonlimiting example embodiment, the first and second wings 320 and 330 are welded to the cross member 310, in another embodiment they are bolted to cross member 310, in yet another embodiment the connection frame 300 is formed through a casting process such that the cross member and wings 320 and 330 constitute a single unitary structure. Regardless, in at least one nonlimiting example embodiment, the cross member 310 and wings 320 and 330 may be, but are not required to be, connected so as to form a single unitary structure which may, or may not be, easily disassembled.

In example embodiments, the chute 100 may be part of a chute assembly 1000 which may include the chute 100 and collar 110. Additionally, the chute assembly 1000 may include side members 120 (see FIG. 1) and 130 (see FIG. 2) which may connect to the collar 110 and interface with the wings 320 and 330 of the connection frame 300. For example, in one nonlimiting example embodiment, the first and second side members 120 and 130 may resemble plates attached to the collar 110 and arranged near the wings 320 and 330 and may be pivotally connected to the wings 320 and 330 via pins 140 and 150. Thus, the side members 120 and 130 may pivot with respect to the wings 320 and 330 of the connection frame 300. In this sense, the pins 140 and 150 form a substantially horizontal pivot axis about which the chute 100 may pivot. As shown in at least FIGS. 1 and 2, the substantially horizontal pivot axis may be arranged above the exit 210 of the mixing auger 200.

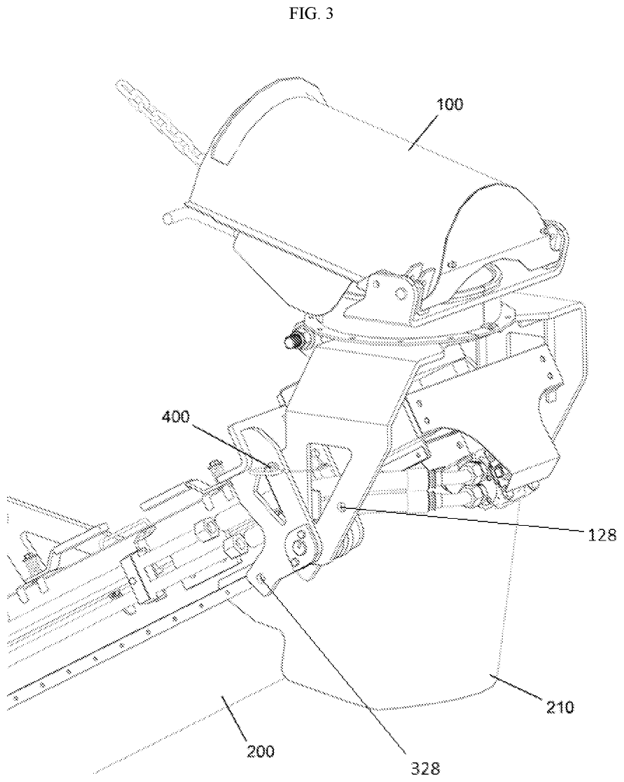

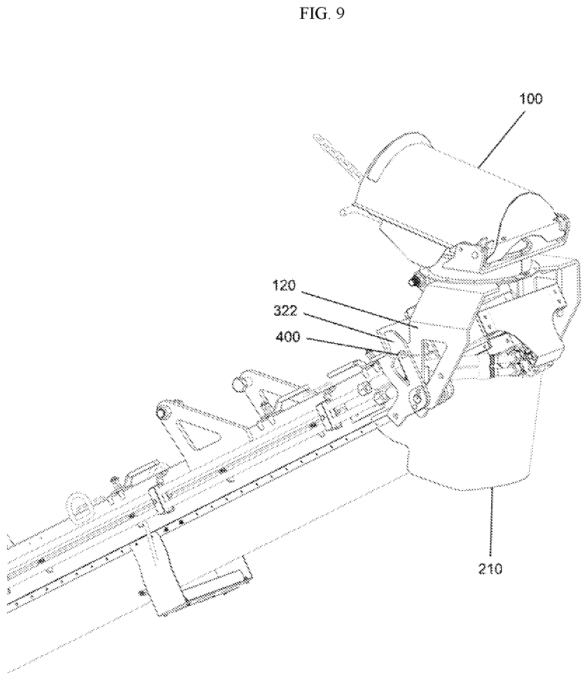

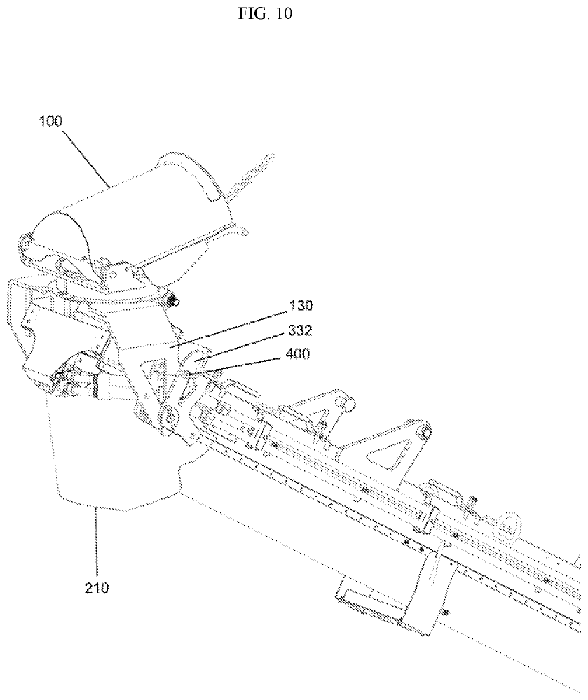

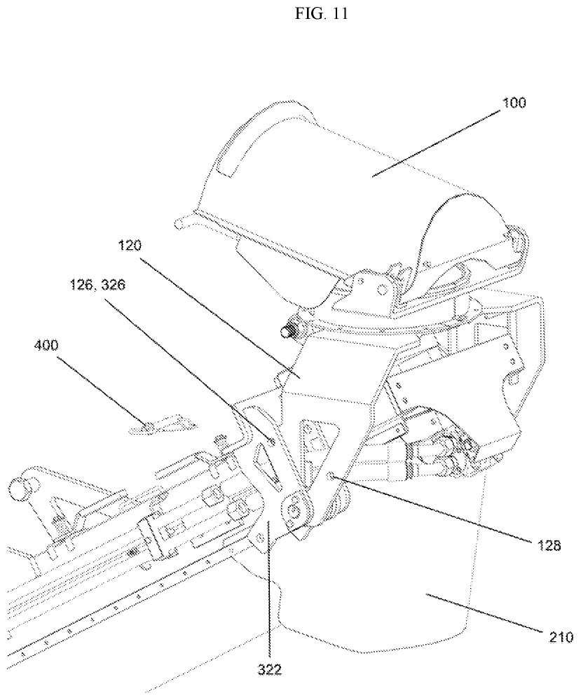

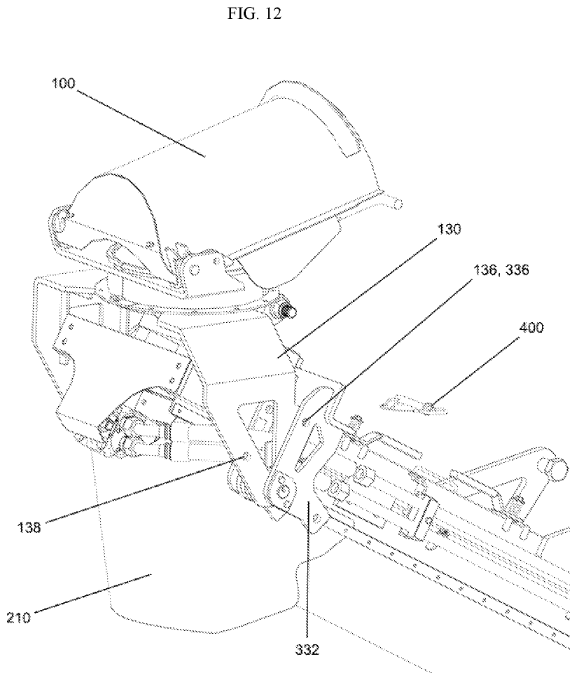

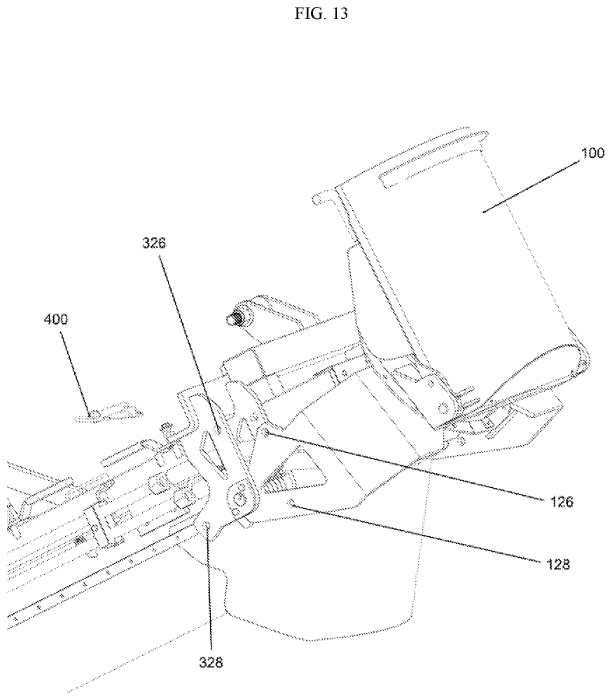

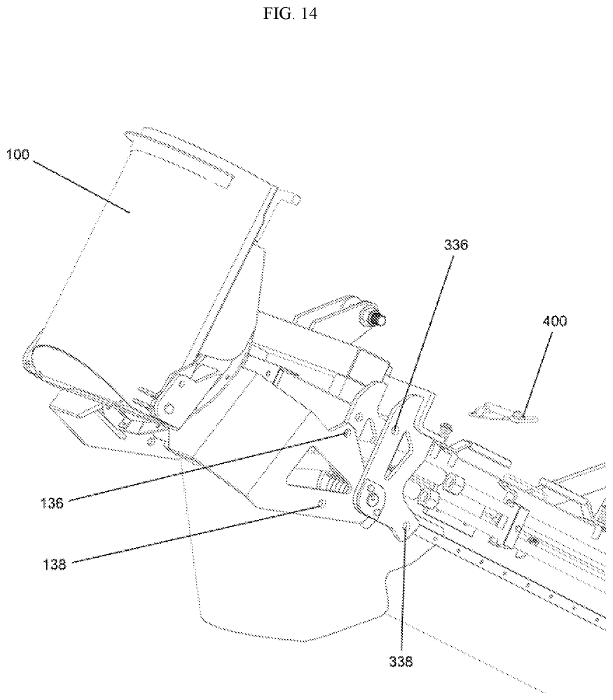

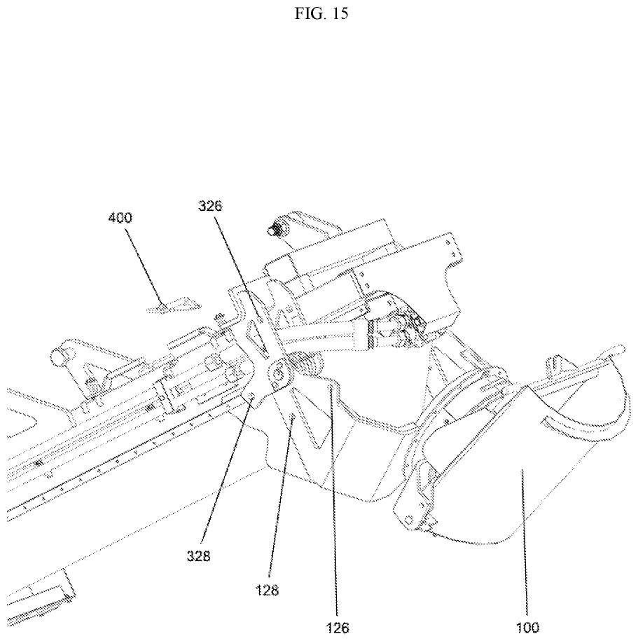

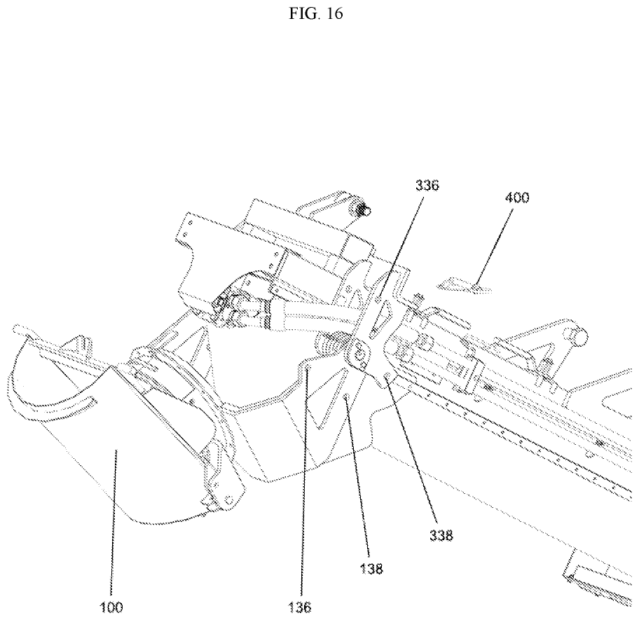

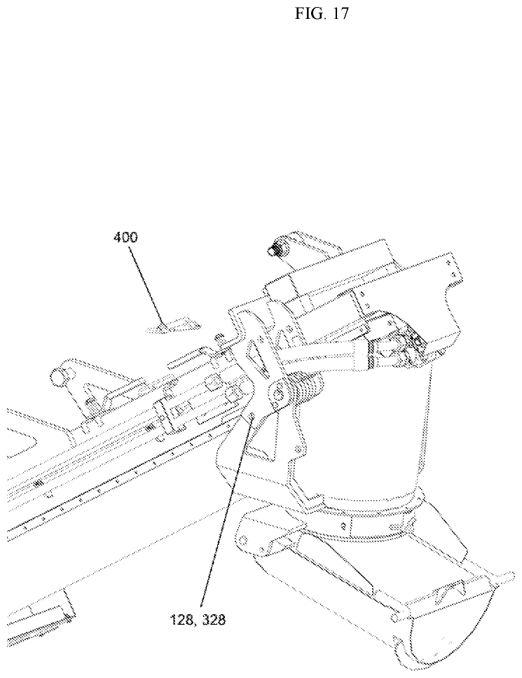

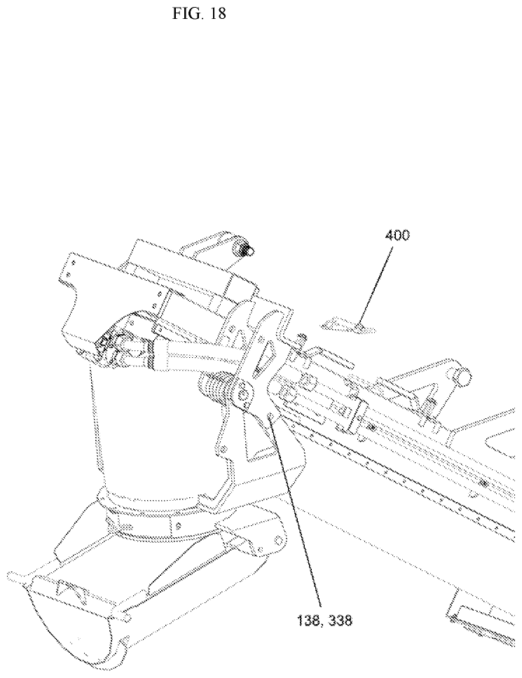

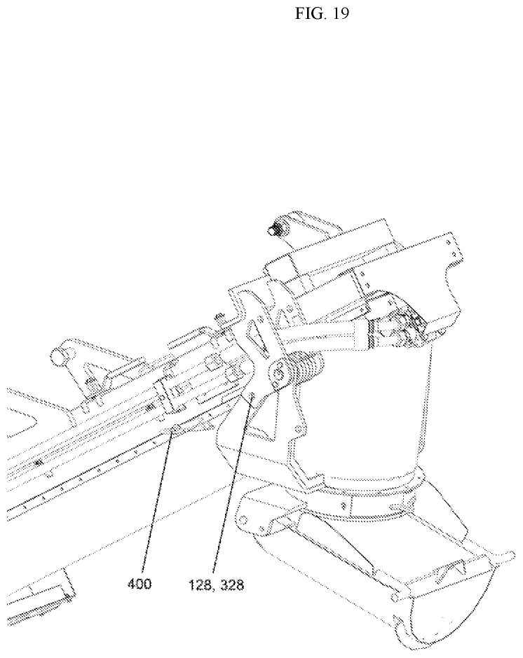

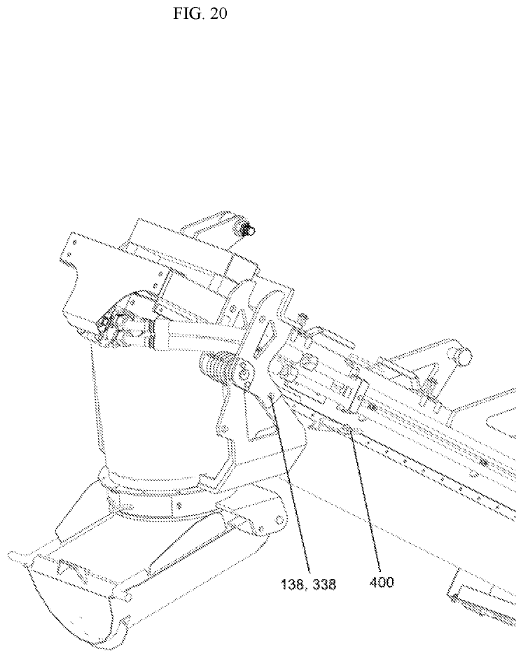

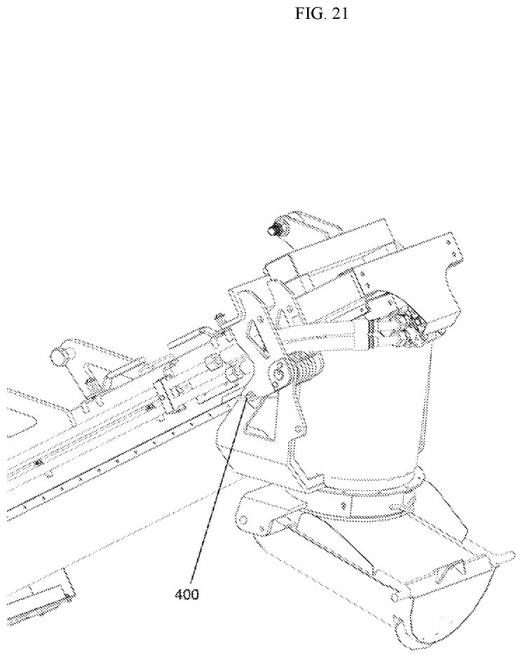

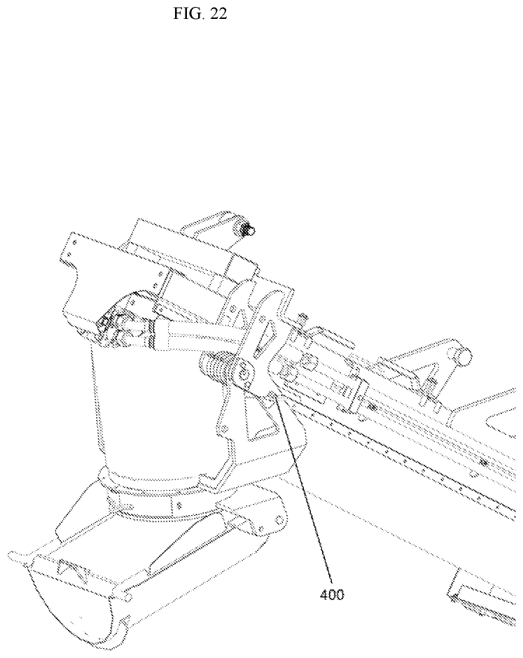

In example embodiments it may be desirable to lock the chute 100 in a particular position. Thus, the invention disclosed herein may include locking members. For example, in one nonlimiting example embodiment, the first and second wings 320 and 330 of the connection frame 300 may include apertures 326, 328, 336, and 338 which may be alignable with apertures 126, 128, 136, and 138 that may be present in the side members 120 and 130. A pin 400, for example, a cotter pin or a spring loaded pin, may thereafter be used to secure the chute 100 in a first position (as shown in FIG. 1) where concrete can be poured onto the chute or in a second position (as shown in FIG. 3) where the chute 100 is rotated upwards to facilitate a continuous pour operation. FIGS. 9-22 show an example of locking the chute 100 in the two aforementioned positions. FIGS. 9-10, for example, show the chute 100 locked in the second position. In FIGS. 9-10, apertures 126 and 326 are aligned and a pin 400 passes through the apertures 126 and 326 to lock the chute 100 in the second position. It is understood the second wing 330 and the second side member 130 may include aligned apertures 336, 136 through which a pin 400 is inserted thereby further securing the chute 100 in the second position. To lower the chute to the first position, the pin(s) 400 is/are removed as shown in FIGS. 11-12. With the pin(s) 400 removed, the chute 100 may be rotated downwards as shown in FIGS. 13 through 18 until apertures 128 and 328 are aligned as shown in FIGS. 19-20. It is understood that the when this happens apertures 138 and 338 may also be aligned. In this configuration, the pin 400 can be moved into the apertures 128 and 328 as shown in FIGS. 21-22 (an/or the pin can be moved into the apertures 138 and 338) to lock the chute 100 in the first position. These operations may be reversed to move the chute 100 back to the second position.

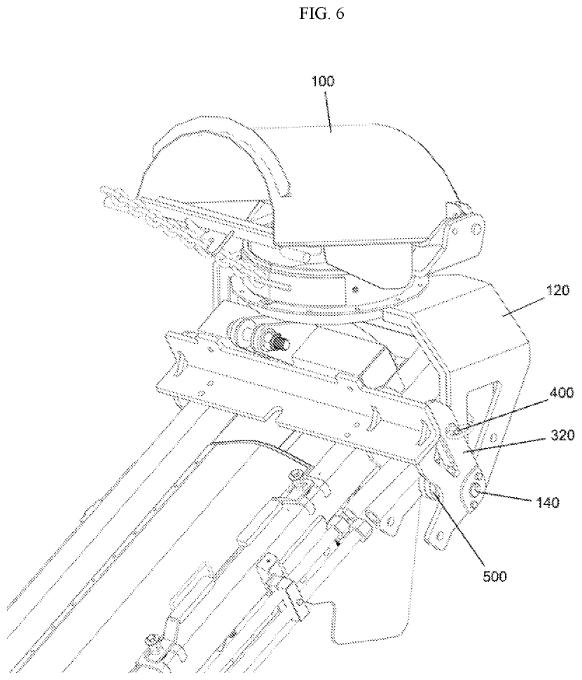

In example embodiments the chute 100 may be difficult to rotate upwards, thus, in one nonlimiting example embodiment, biasing members 500 are included to assist a user in rotating the chute 100 upwards. The biasing members 500, in one nonlimiting example embodiment may be torsion springs, however, the invention is not limited thereto. In example embodiments two biasing members 500 may be provided and may be aligned with the pins 140 and 150 as shown in FIGS. 1 and 2, however, this is not intended to limit the invention. For example, only a single biasing member 500 may be provided over, for example, pin 140. For example, the embodiment illustrated in at least FIGS. 5 and 6 utilize only a single biasing member 150 associated with the first side member 320.

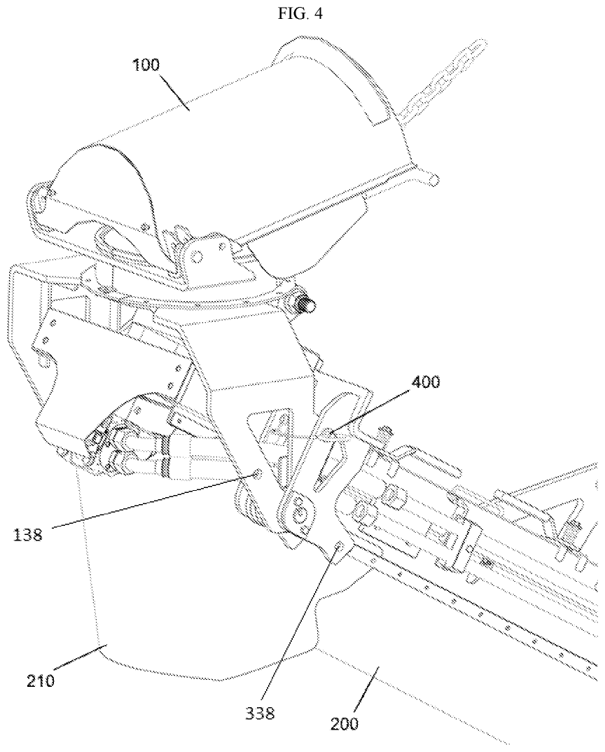

In example embodiments the chute 100 may be locked into a first position as shown in FIGS. 1 and 2 or in a second position as shown in FIGS. 3 and 4. In the second position the chute 100 is rotated above the mixing auger 200 as shown in at least FIGS. 3 and 4, however, this is not intended to limit the invention as the connection frame 300 and chute assembly 1000 may be configured so that the chute 100 is rotated just far enough so that concrete may freely pour out the exit 210 of the mixing auger.

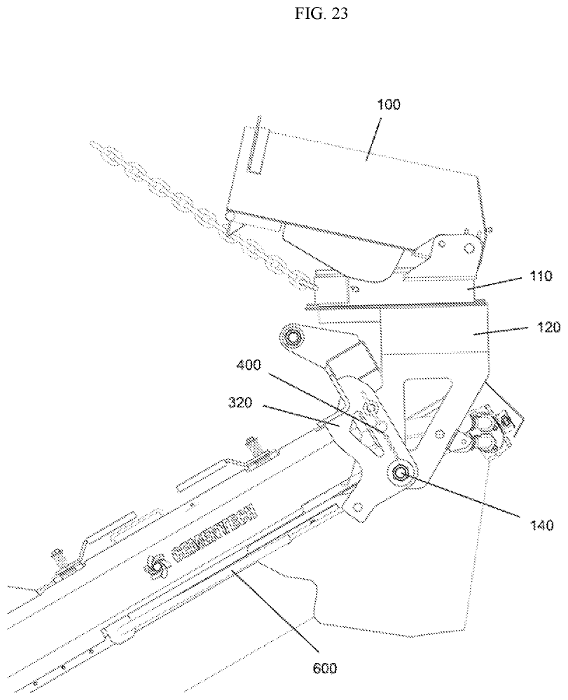

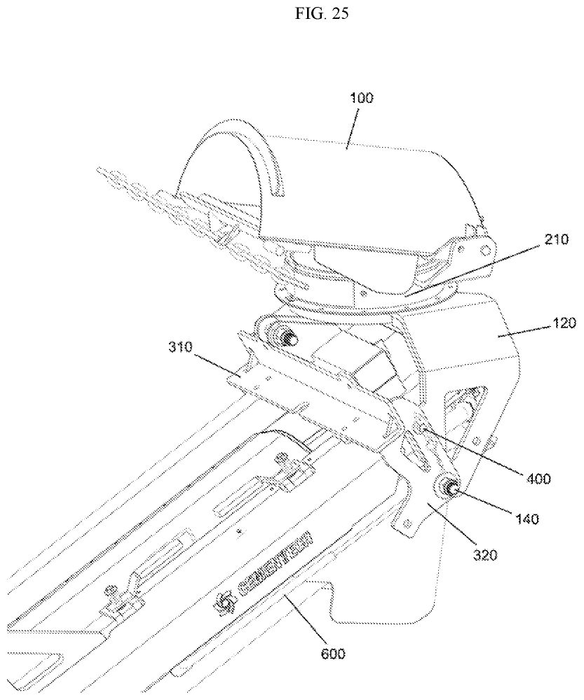

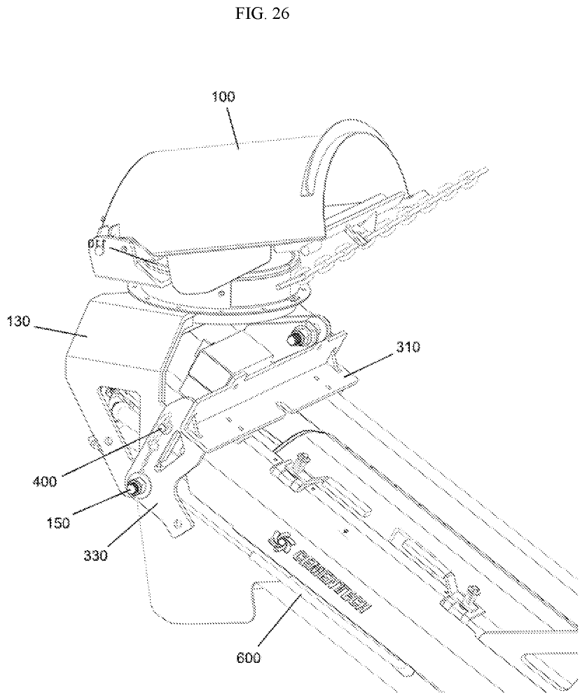

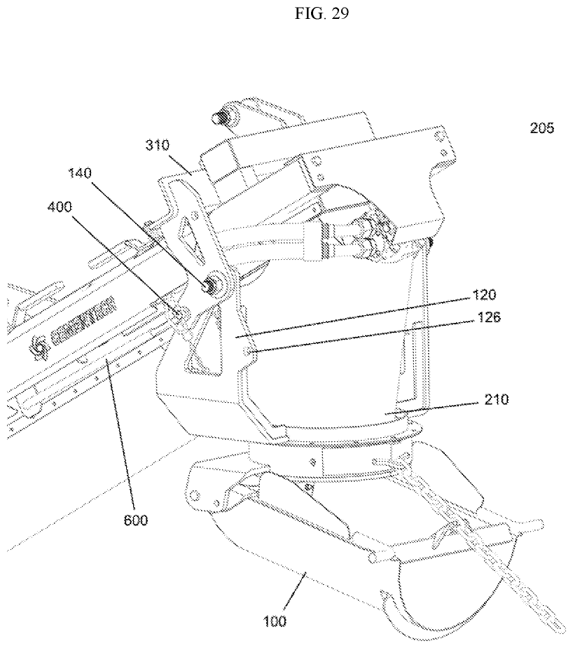

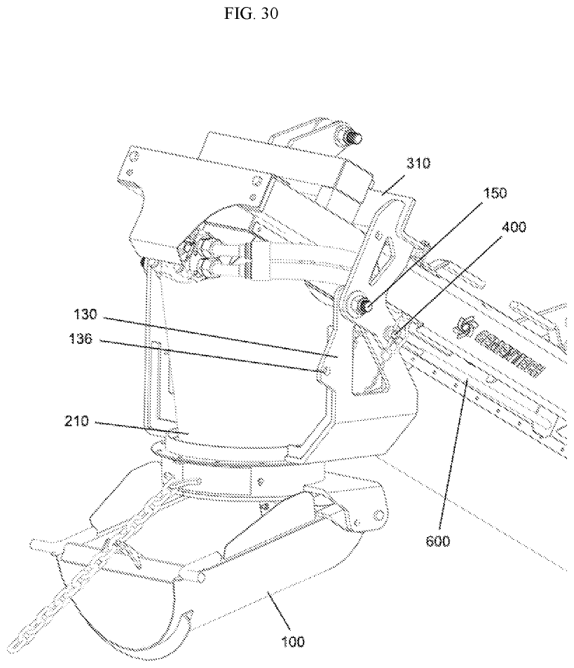

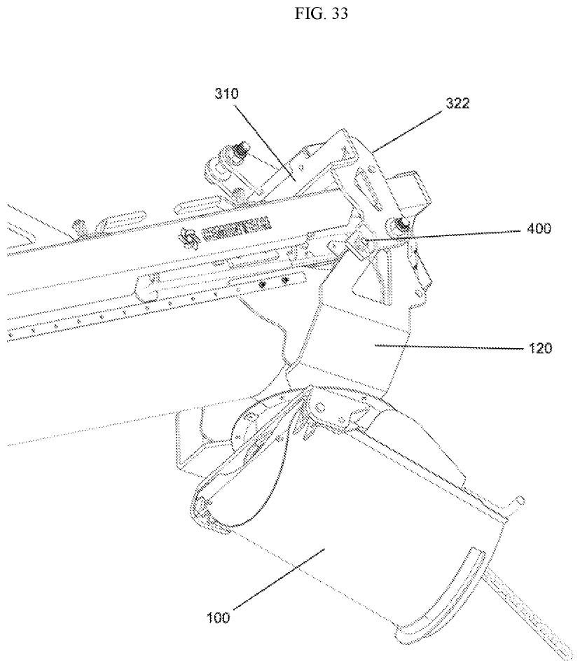

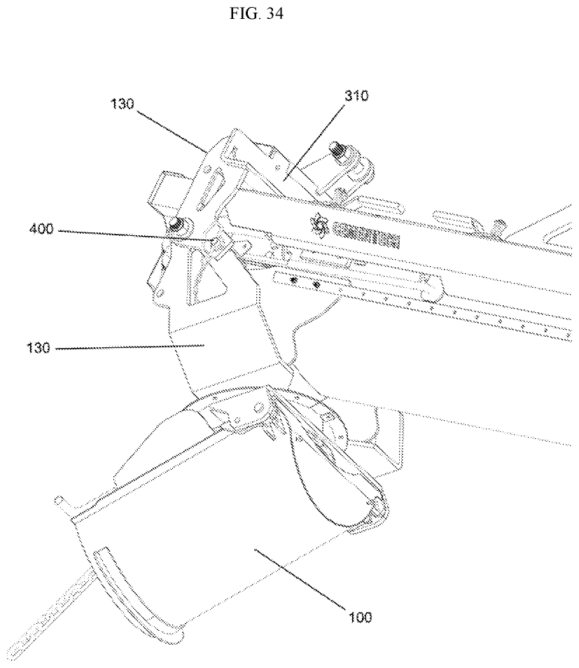

The above description is not intended to limit the invention as the inventive concepts cover several other configurations and embodiments. For example, FIGS. 23-34 illustrate a similar assembly, however, in FIGS. 23-34 an actuator 600 which may function as a biasing member to move the chute 100 with respect to the mixing auger 200. The actuator 600, in one embodiment, may be a hydraulic cylinder. In another embodiment the actuator 600 may be a pneumatic cylinder. In yet another embodiment the actuator 600 may be an electrically driven actuator. Regardless, in this example embodiment, the actuator 600 may be operated to control movement of the chute 100 from the previously described first and second positions. Although a skilled artisan would understand how to install the actuator in the embodiment of FIGS. 23-34, for the sake of clarity, in one example embodiment, a barrel end of actuator 600 (when the actuator is embodied as a hydraulic cylinder) may be attached either directly or indirectly to the mixing auger 200 and the piston of the actuator 600 may be attached to the chute assembly 1000, for example, at the firs side member 120 or the second side member 130.

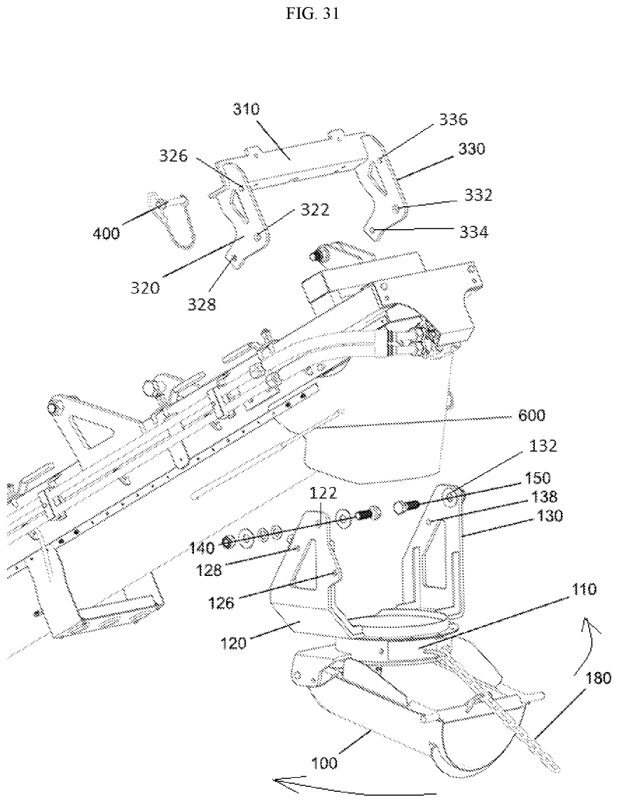

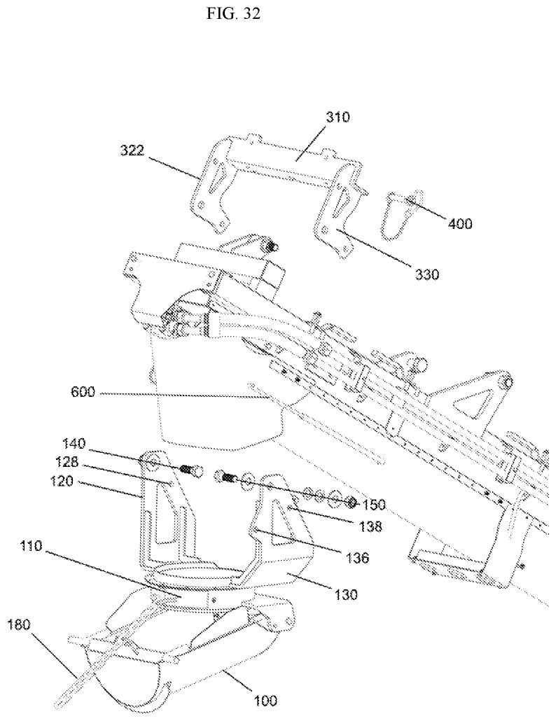

FIGS. 31-32 are exploded views of a system having mixing auger 200 and an exemplary pivotal chute assembly 1000 attached to the mixing auger 200. As shown in FIGS. 31-32, the pivotal chute assembly 1000 includes a chute 100 attached to a collar 110 which in turn is attached to the mixing auger 200 by a connection frame 300 via a pair of side members 120 and 130. The side members 120 and 130 may be fixed to the collar 110 so that the side members 120 and 130 and the collar 110 move as one member. The collar 110, however, allows the chute 100 to pivot about an axis that extends through the collar 110. The collar 110, for example, may resemble a ring in a ring where the chute 100 is attached to one ring with rotates with respect to the other ring. In example embodiments the side members 120 and 130 may resemble plates but may take on any suitable shape. For example, the side members 120 and 130 may be made from tubes or some other structural member. In addition, while the side members 120 and 130 may resemble substantially flat plates they may be formed/configured, to provide space for other elements like hydraulic hoses. For example, side member 120 may substantially resemble a bent plate whereas side plate 130 may substantially resemble a flat vertical plate.

As in the previous example embodiment, the connection frame 300 of FIGS. 23-34 may include a cross member 310 which crosses a top of the mixing auger 200. In one nonlimiting example embodiment, the cross member 310 is bolted to a top of the mixing auger 200, in another nonlimiting example embodiment it is welded to the top of the mixing auger 200. In the various figures the cross member 310 is illustrated as having a L-shaped cross-section, however the invention is not limited thereto. For example, rather than having an L-shaped cross-section, the cross member 310 may have another cross-sectional shape such as, but not limited to, a rectangular cross section, a C-shaped cross-section, an I-shaped cross-section, an H-shaped cross-section, or a W-shaped cross-section.

In example embodiments the connection frame 300 may include a first wing 320 and a second wing 330 (which may resemble flat plates) extending therefrom and along sides of the mixing auger 200. Pivotal connections from the wings 320 and 330 to the side members 120 and 130 may be facilitated through the use of apertures and pins/bolts/etc. For example, in one nonlimiting embodiment the first wing 320 may have a first aperture 322 alignable with a first aperture 122 of the first side member 120. Similarly, the second wing 330 may have a first aperture 332 alignable with a first aperture 132 of the second side member 130. A bolt and nut connection assembly 140 may be used to connect the first wing 320 to the first side member 120 and a second bolt and nut connection assembly 150 may be used to connect the second wing 330 to the second side member 130. In this manner the side members 120 and 130 are pivotally connected to the wings 320 and 330 of the connection frame 300. It should be understood that this type of pivotal connection is meant for purpose of illustration only rather than limitation since one skilled in the art would know of various ways to pivotally connect the side members 120 and 130 to the wings 320 and 330.

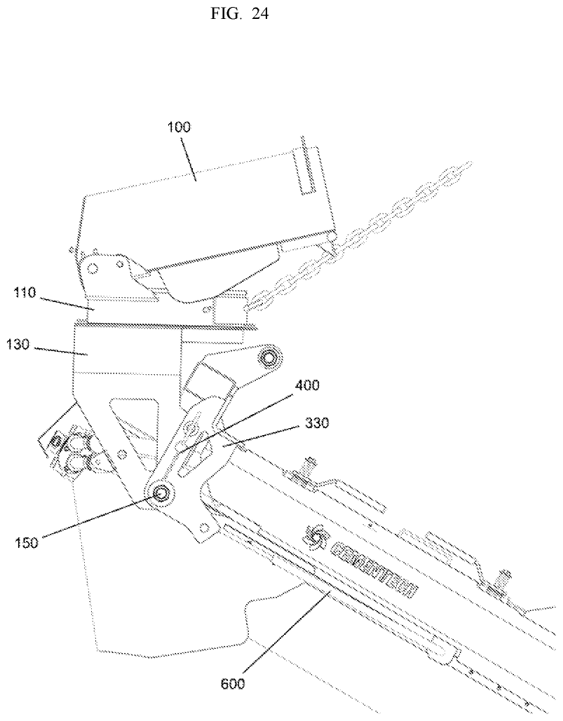

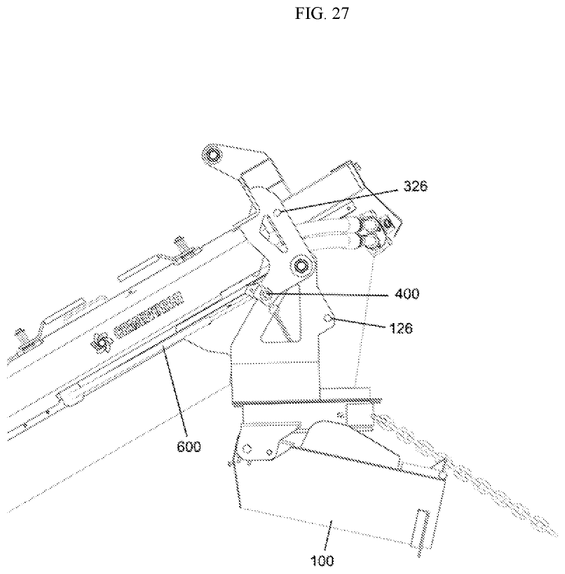

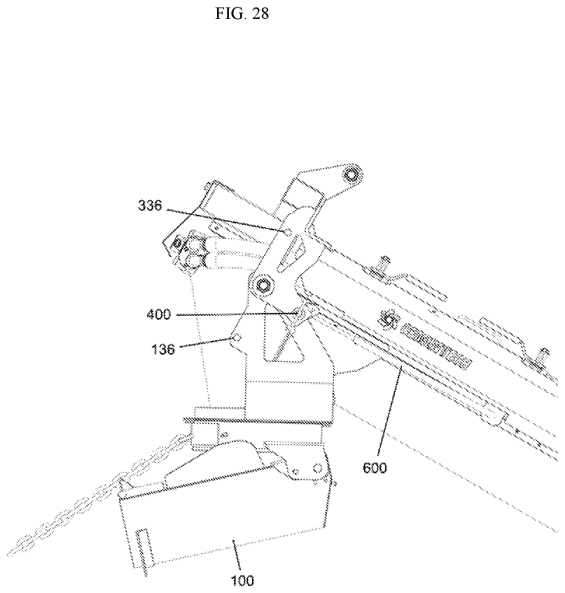

As in the previous example embodiment, the embodiment of FIGS. 23-34 may allow for the chute 100 to be pivoted upwards to allow for continuous flow (as shown in FIGS. 23-24 or downwards to allow for a directional flow as shown in FIGS. 27-28. Like in the previous embodiment, the chute 100 may be locked in a first configuration by using apertures and pins. For example the first wing 320 may have a second hole 326 alignable with a second hole 126 of the first side plate 120 so that when a pin 400 is inserted therein the chute 100 is locked in an upward position as shown in FIGS. 23-24. Further, the first wing 320 may have a third hole 328 which is alignable with a third hole 128 of the first side member 120 such that when the chute 100 is rotated downwards the third holes 328 and 128 may align allowing a pin 400 to be inserted therein to lock the chute 100 in the downwards position.

In example embodiments the chute 100 may be pivoted upwards under the influence of actuator 600. For example, one end of the actuator 600 may be attached to the mixing auger 200 while another end of the actuator 600 may be attached to the first side member 120. Thus, as the actuator 600 extends or contracts the chute 100 may be pivoted upwards or downwards. In some embodiments, a second actuator 600 may be attached on another side of the mixing auger 200. For example, this second actuator 600 may attach to the second side member 130 which may cause the second side member 130 to pivot upwards or downwards. In at least one embodiment, when two actuators are used, the actuators may be controlled to ensure there is not twisting of the chute assembly 1000.

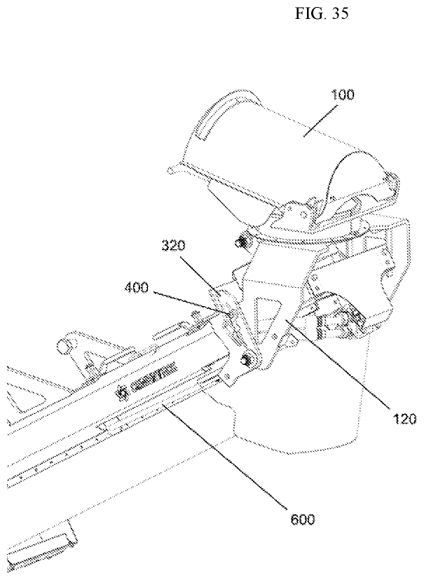

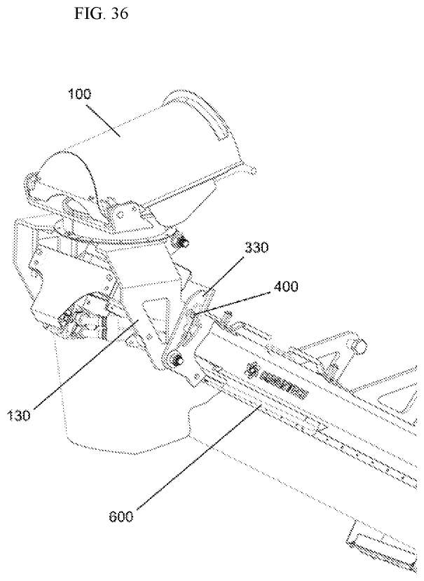

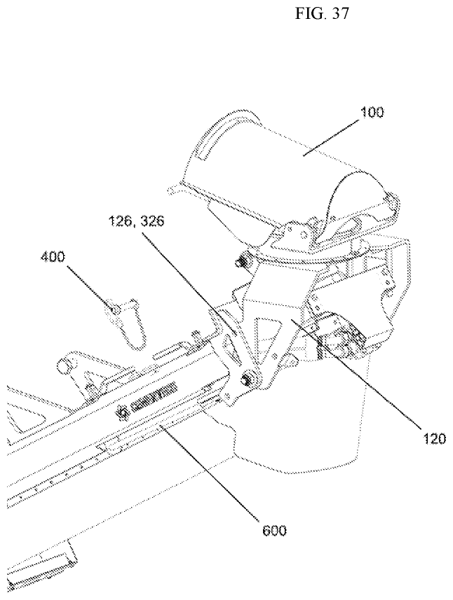

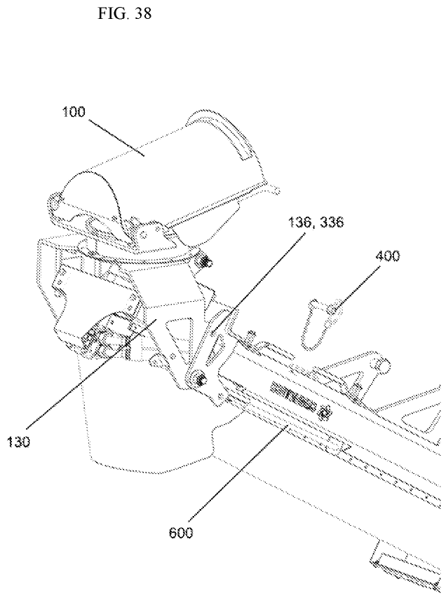

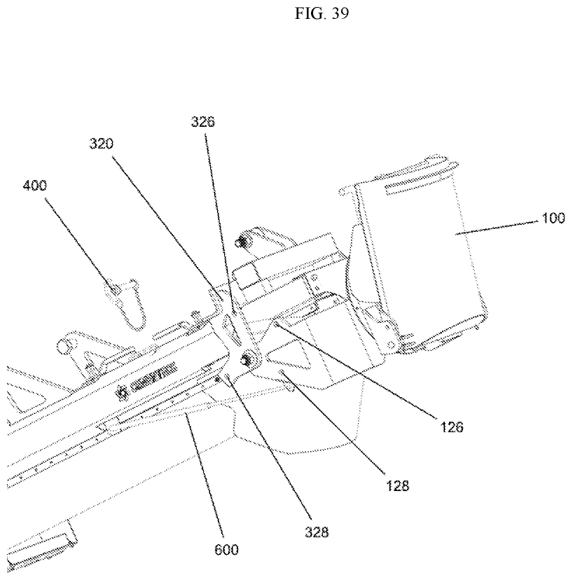

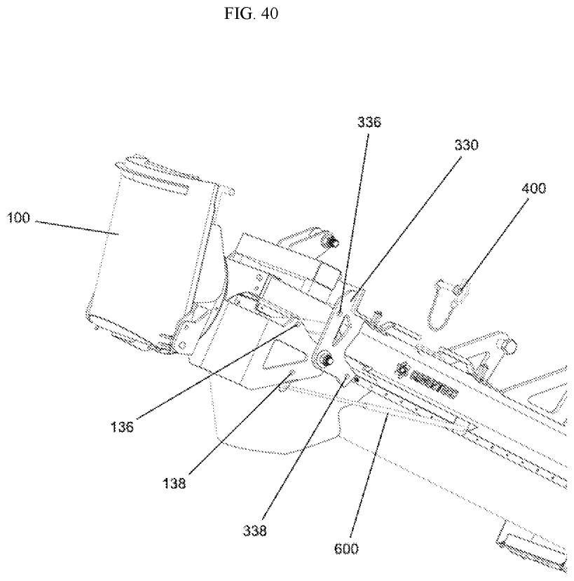

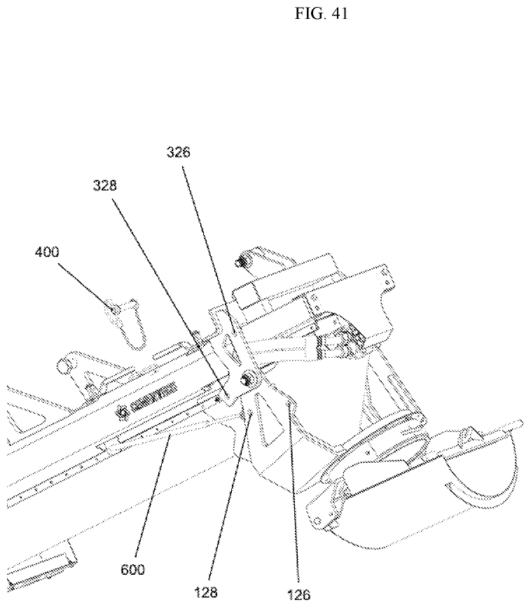

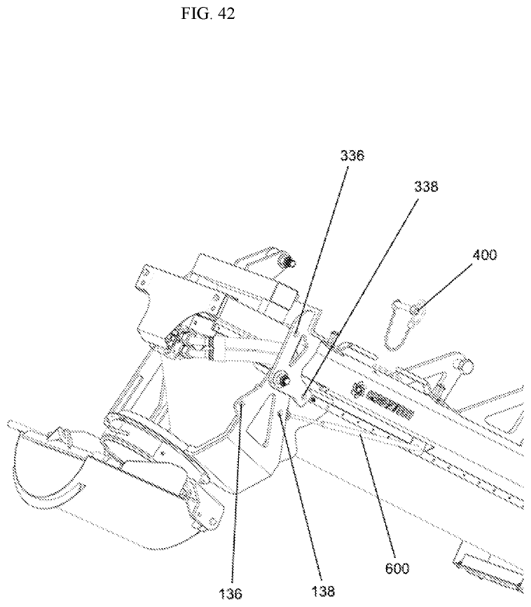

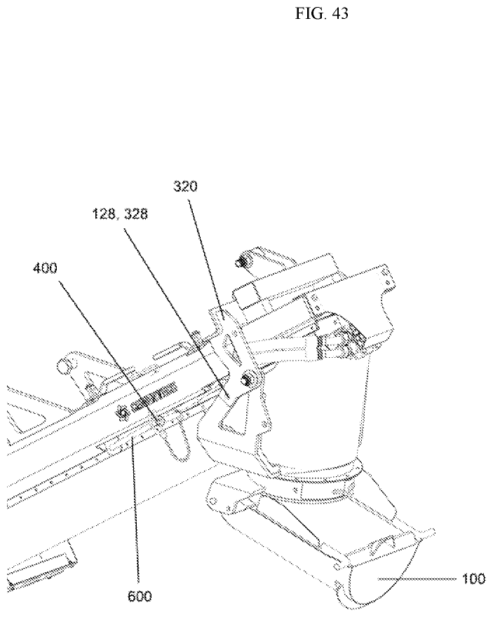

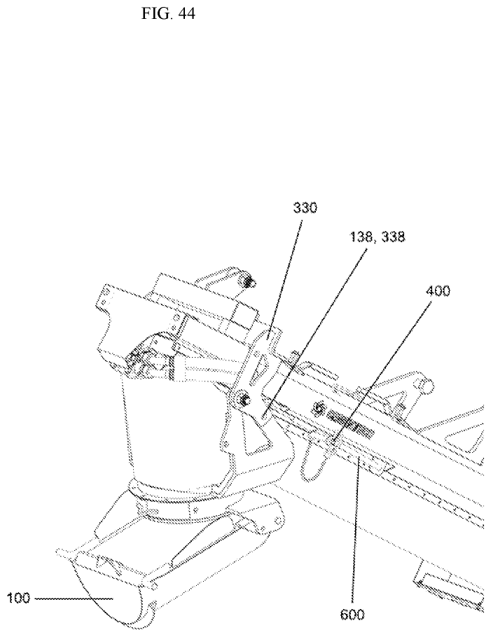

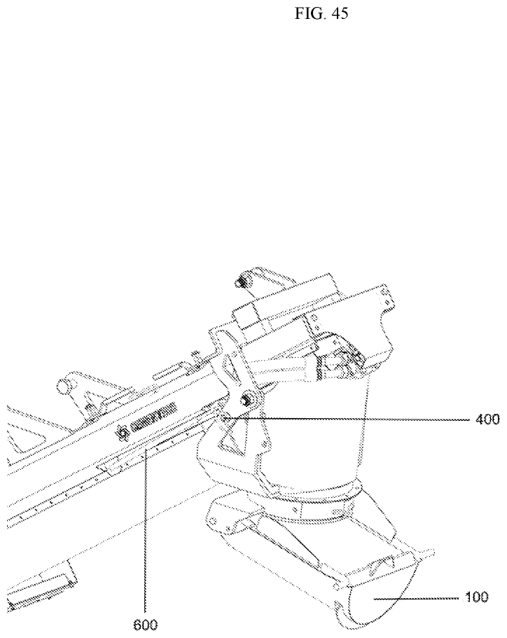

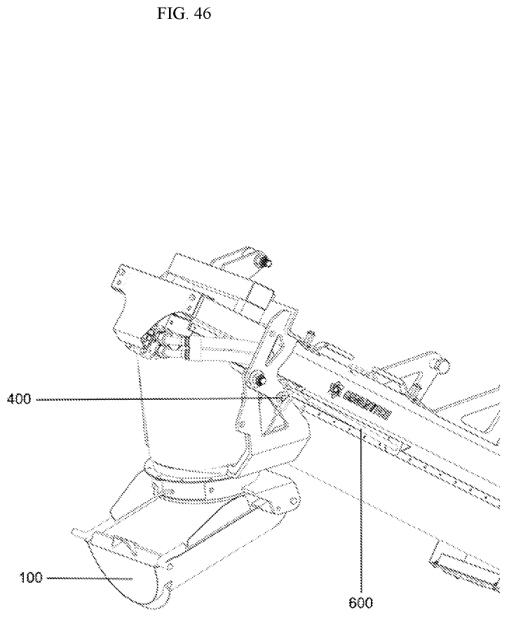

FIGS. 35-46 show an example of locking the chute 100 in the two aforementioned positions. FIGS. 35 and 36, for example, show the chute 100 locked in the second position. In FIGS. 35 and 36, apertures 126 and 326 are aligned and a pin 400 passes through the apertures 126 and 326 to lock the chute 100 in the second position. To lower the chute to the first position, the pin 400 is removed as shown in FIGS. 37-38. With the pin 400 removed, the chute 100 may be rotated downwards, under the influence of actuator(s) 600, as shown in FIGS. 39 to 42 until apertures 128 and 328 are aligned as shown in FIGS. 43 and 44. In this configuration, the pin 400 can be moved into the apertures 128 and 328 as shown in FIGS. 45 and 46 to lock the chute 100 in the second position. These operations may be reversed to move the chute 100 back to the second position.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A volumetric mixer comprising:
a mixing auger, and
a chute pivotally connected to the mixing auger such that a pivot axis of the chute is substantially horizontal.

2. The volumetric mixer of claim 1, wherein the pivot axis is located above an exit of the mixing auger.

3. The volumetric mixer of claim 1, wherein the chute is configured to be locked in a first position to receive concrete from the mixing auger and rotatable about a horizontal axis to move the chute to a second position where the chute can be locked in a second position to allow concrete flowing out an exit of the mixing auger without contact the chute.

4. The volumetric mixer of claim 1, wherein the chute is also configured to pivot about a substantially vertical axis.

5. The volumetric mixer of claim 1, further comprising:
a connection frame attached to the mixing auger, and
a chute assembly having the chute, the chute assembly having a first side member and a second side member pivotally connected to the connection frame.

6. The volumetric mixer of claim 5, wherein the pivot axis passes through the first and second side members of the chute assembly.

7. The volumetric mixer of claim 6, wherein the pivot axis also passes through the connection frame.

8. The volumetric mixer of claim 1, further comprising:
at least one biasing member configured to bias the chute assembly.

9. The volumetric mixer of claim 8, wherein the at least one biasing member is at least one of a torsion spring and actuator.

10. The volumetric mixer of claim 9, wherein the actuator is one of a hydraulic cylinder, a pneumatic cylinder, and an electric actuator.

11. The volumetric mixer of claim 1, further comprising:
at least one pin configured to lock the chute in one of two position.

12. A volumetric mixer comprising:
a mixing auger; and
a chute assembly having chute, the chute assembly being configured to pivot the chute about a horizontal axis and a vertical axis and so the chute can be locked in a first position to receive concrete from the mixing auger and a second position to allow continuous pour of concrete out of the mixing auger.

13. The volumetric mixer of claim 12, wherein the horizontal and vertical axis each pass through an end of the mixing auger.

14. The volumetric mixer of claim 13, wherein the chute assembly includes a collar to allow the chute to pivot about a vertical axis.

15. The volumetric mixer of claim 14, wherein the chute assembly includes side members arranged at sides of the mixing auger and the horizontal axis passes through the side members.

16. The volumetric mixer of claim 15, further comprising:
a connection frame attached to the mixing auger, the connection frame connecting the chute assembly to the auger and having wings through which the horizontal axis passes.

17. A volumetric mixer, comprising:
a mixing auger;
a connection frame attached to an end of the mixing auger, the connection frame having a first wing facing a first side of the mixing auger and a second wing facing a second side of the connection frame; and
a chute assembly pivotally attached to the connection frame, the chute assembly including a first side member pivotally connected to the first wing of the connection frame at a first pivot point and a second side member pivotally connected to the second wing of the connection frame at a second pivot point, the first side member of the chute assembly having a first hole offset from the first pivot point and a second hole offset from the first pivot point, the first hole being alignable with a first hole of the first wing of the connection frame and the second hole being alignable with a second hole of the first wing of the connection frame; and
an actuator configured to pivot the chute assembly with respect to the connection frame.

18. The volumetric mixer of claim 17, wherein the actuator is a hydraulic cylinder having a barrel attached to the mixing auger and a rod attached to the first side member of the chute assembly.

19. The volumetric mixer of claim 17, further comprising a pin passing through the first hole of the first side member of the chute assembly and the first hole of the first side member of the connection frame to lock the chute assembly in a first position.

20. The volumetric mixer of claim 17, further comprising a pin passing through the second hole of the first side member of the chute assembly and the second hole of the first side member of the connection frame to lock the chute assembly in a second position.
